(19) United States
(12) Patent Application Publication
(10) Pub. No.: US 2016/0031541 A1
(43) Pub. Date: Feb. 4, 2016

(54) WATERCRAFT AND MARINE PROPULSION DEVICE

(71) Applicant: YAMAHA HATSUDOKI KABUSHIKI KAISHA, Iwata-shi (JP)

(72) Inventors: Yoshiyuki KADOBAYASHI, Shizuoka (JP); Hiroyuki MATSUMOTO, Shizuoka (JP)

(21) Appl. No.: 14/596,416

(22) Filed: Jan. 14, 2015

(30) Foreign Application Priority Data
Aug. 1, 2014 (JP) 2014-157448

(51) Int. Cl. B63H 21/38; F02D 41/26; F02B 61/04

(52) U.S. Cl. CPC B63H 21/38; F02B 61/045; F02D 41/26

(57) ABSTRACT

A watercraft includes a hull, an engine, a fuel supply system, a phase separation detecting sensor, a control unit, and an informing device. The engine is attached to the hull. The fuel supply system includes a fuel tank and a fuel pipe. The fuel tank is disposed on the hull. The fuel pipe connects the fuel tank and the engine. The phase separation detecting sensor is attached to the fuel supply system and is configured to detect a possibility of occurrence of phase separation in a fuel. The control unit is configured or programmed to output an informing signal when a determination is made that the possibility of occurrence of phase separation in the fuel is high on a basis of an output of the phase separation detecting sensor. The informing device is configured to inform that the possibility of occurrence of phase separation in the fuel is high when receiving the informing signal from the control unit.

### BACKGROUND OF THE INVENTION

1. Field of the Invention

The present invention relates to a watercraft and a marine propulsion device.

2. Description of the Related Art

The diversity of fuels for automobile engines, the fuels for watercraft engines, and alcohol containing fuels produced by blending gasoline with alcohol, such as ethanol, have been increasing in a number of countries.

Alcohol containing fuels absorb moisture in the air. Thus, the water concentration in alcohol containing fuels increases. A phenomenon of separation between gasoline and water, which is called phase separation, is caused when the water concentration in the alcohol containing fuel reaches a predetermined concentration or greater. Alcohol is highly hydrophilic and is inevitably trapped into a water layer when phase separation occurs. In this case, chances are that the octane number of the fuel or the vapor pressure is reduced and the function of an engine or a fuel system is thus degraded.

In view of the above, measures for avoiding the above described situation have been facilitated in automobiles by, for instance, preliminarily detecting phase separation with the use of a technology as described in Japan Laid-open Patent Application Publication No. JP-A-2007-262915.

However, the storage environment or the usage environment of watercrafts is physically closer to water than that of vehicles for use on the ground such as automobiles and motorcycles. Further, watercrafts include a fuel tank with a large capacity, and require less frequent refilling of the fuel tank with fresh fuel. Thus, water is likely to be accumulated in the fuel of a watercraft.

Further, watercrafts such as a boat equipped with an outboard motor include a structure having a fuel pipe to feed fuel to the engine that is detachable so as to inspect the outboard motor or to refill the outboard motor with fuel. Therefore, the fuel can be contaminated with water through a connector portion of the fuel pipe. Thus, phase separation is likely to be caused in alcohol containing fuels in watercrafts used in a waterfront environment.

### SUMMARY OF THE INVENTION

Preferred embodiments of the present invention provide a watercraft and a marine propulsion device that significantly reduce or prevent the occurrence of phase separation in an alcohol containing fuel.

A watercraft according to a preferred embodiment of the present invention includes a hull, an engine, a fuel supply system, a phase separation detecting sensor, a control unit, and an informing device. The engine is attached to the hull. The fuel supply system includes a fuel tank and a fuel pipe. The fuel tank is disposed on the hull. The fuel pipe connects the fuel tank and the engine. The phase separation detecting sensor is attached to the fuel supply system and is configured to detect a possibility of occurrence of phase separation in a fuel. The control unit is configured or programmed to output an informing signal when a determination is made that the possibility of occurrence of phase separation in the fuel is high on a basis of an output from the phase separation detecting sensor. The informing device is configured to inform that the possibility of occurrence of phase separation in the fuel is high when the informing signal is received from the control unit.

In the watercraft according to a preferred embodiment of the present invention, the phase separation detecting sensor is configured to detect the possibility of occurrence of phase separation in the fuel in the fuel supply system. The control unit is configured or programmed to output the informing signal when a determination is made that the possibility of occurrence of phase separation is high based on the output of the phase separation detecting sensor. When the control unit outputs the informing signal, the informing device is configured to inform that the possibility of occurrence of phase separation is high. When informed by the informing device, a user of the watercraft recognizes that the possibility of occurrence of phase separation in the fuel (an alcohol containing fuel) is high. Thus, occurrence of phase separation in the fuel is preliminarily prevented.

A marine propulsion device according to another preferred embodiment of the present invention includes a marine propulsion device attached to a hull, and further includes an inside fuel supply system, an engine, a drive shaft, and a phase separation detecting sensor. The inside fuel supply system includes a connector, a sub tank, and a pump. The connector is connected to an outside fuel supply system including a fuel tank disposed on the hull. The sub tank stores fuel. The pump is configured to supply the fuel from the sub tank to the engine. The engine includes a crankshaft and is configured to cause the crankshaft to be rotated by combusting the fuel supplied from the inside fuel supply system. The drive shaft is connected to the crankshaft. The phase separation detecting sensor is attached to the inside fuel supply system and is configured to detect a possibility of occurrence of phase separation in the fuel.

In the marine propulsion device according to a preferred embodiment of the present invention, the phase separation detecting sensor is configured to detect the possibility of occurrence of phase separation in the fuel in the inside fuel supply system. Thus, occurrence of phase separation in the alcohol containing fuel is preliminarily prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a watercraft according to a preferred embodiment of the present invention.

FIG. 2 is a side view of a marine propulsion device according to a preferred embodiment of the present invention.

FIG. 3 is a schematic diagram of a fuel supply system of the watercraft.

FIG. 4 is an enlarged cross-sectional view of a structure including a connector and the surrounding elements.

FIG. 5 is a schematic diagram of a communication system on the watercraft.

FIG. 6 is a schematic diagram of a phase separation water ratio sensor.

FIG. 7 is a flowchart representing a processing to be performed by an ECU.

FIG. 8 is a schematic diagram of a fuel supply system of a watercraft according to a first modification of a preferred embodiment of the present invention.

FIG. 9 is a schematic diagram of a communication system on the watercraft according to a second modification of a preferred embodiment of the present invention.

FIG. 10 is a side view of a marine propulsion device according to a third modification of a preferred embodiment of the present invention.

FIG. 11 is a side view of a marine propulsion device according to a fourth modification of a preferred embodiment of the present invention.

FIG. 12 is a cross-sectional view of a watercraft according to another preferred embodiment of the present invention.

### DETAILED DESCRIPTION OF THE PREFERRED EMBODIMENTS

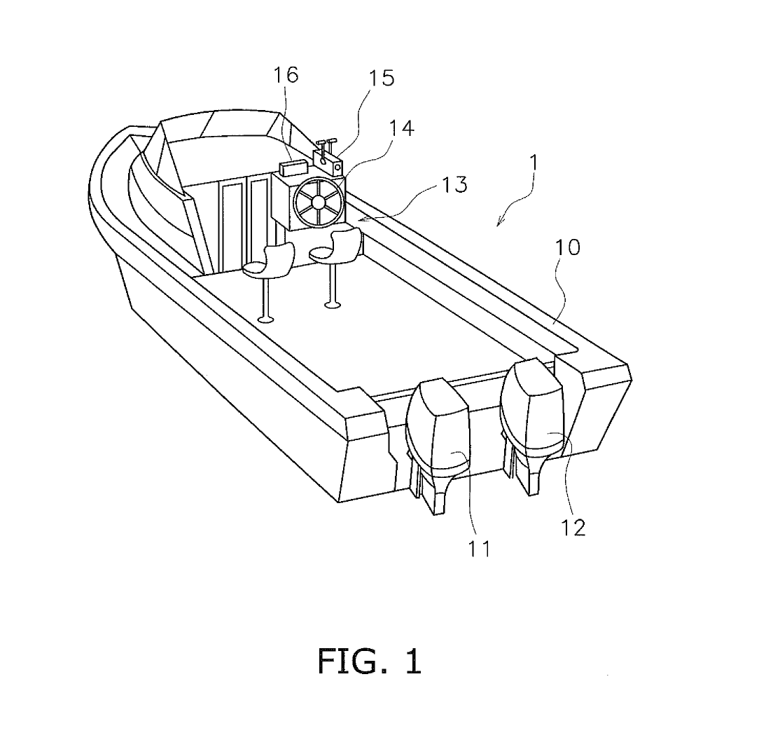

A watercraft 1 according to a preferred embodiment of the present invention will be hereinafter explained with reference to the attached drawings. FIG. 1 is a perspective view of the watercraft 1. As shown in FIG. 1, the watercraft 1 includes a hull 10 and a plurality of marine propulsion devices 11 and 12. In the present preferred embodiment, the watercraft 1 includes the two marine propulsion devices 11 and 12, for example. However, the number of the marine propulsion devices is not limited to two and may be one. Alternatively, the number of the marine propulsion devices may be three or more. The marine propulsion devices 11 and 12 are attached to the stern of the hull 10. The marine propulsion devices 11 and 12 are configured to generate thrust to propel the watercraft 1.

The hull 10 includes a vessel operating seat 13. The vessel operating seat 13 is disposed forward of the marine propulsion devices 11 and 12. A steering device 14, a remote control device 15, and an indication device 16 are disposed near the vessel operating seat 13. The steering device 14 is a device that enables an operator to control the turning direction of the watercraft 1. The remote control device 15 is a device that enables the operator to regulate the vessel speed. The remote control device 15 is a device that enables the operator to switch the moving direction of the watercraft 1 between the forward direction and the rearward direction. The indication device 16 is a device configured to indicate information regarding the watercraft 1. The indication device 16 is disposed in the vicinity of the vessel operating seat 13. The indication device 16 preferably includes, for instance, a plurality of meters and indicator lights. Alternatively, the indication device 16 may be a display device.

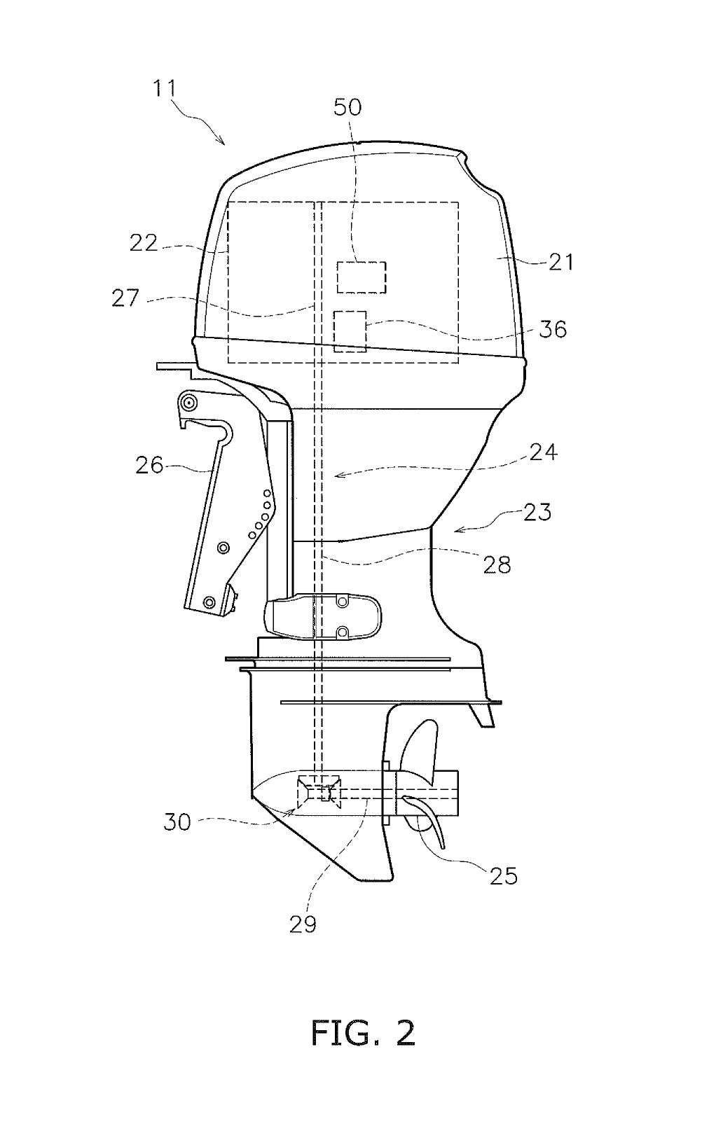

FIG. 2 is a side view of the marine propulsion device 11. The two marine propulsion devices 11 and 12 are similarly structured. Thus, one of the marine propulsion devices, i.e., the marine propulsion device 11, will be hereinafter explained. In the present preferred embodiment, the marine propulsion device 11 preferably is an outboard motor, for example. The marine propulsion device 11 includes an engine cover 21 (cowling), an engine 22, a casing 23, a power transmission mechanism 24, a propeller 25, and a bracket 26. The engine cover 21 accommodates the engine 22. The engine 22 includes a crankshaft 27. The crankshaft 27 extends in the up-and-down direction.

The casing 23 is disposed under the engine cover 21. The propeller 25 is disposed in the lower portion of the marine propulsion device 11. The propeller 25 is configured to be driven and rotated by a driving force from the engine 22. The marine propulsion device 11 is attached to the hull 10 through the bracket 26. The power transmission mechanism 24 is disposed within the casing 23. The power transmission mechanism 24 is configured to transmit the driving force from the engine 22 to the propeller 25. The power transmission mechanism 24 includes a drive shaft 28, a propeller shaft 29, and a shift mechanism 30.

The drive shaft 28 is disposed along the up-and-down direction. The drive shaft 28 is coupled to the crankshaft 27. The propeller shaft 29 is disposed along the back-and-forth direction. The propeller shaft 29 is coupled to the lower portion of the drive shaft 28 through the shift mechanism 30. The propeller shaft 29 is configured to transmit a driving force from the drive shaft 28 to the propeller 25. The shift mechanism 30 is configured to switch the rotational direction of power to be transmitted from the drive shaft 28 to the propeller shaft 29.

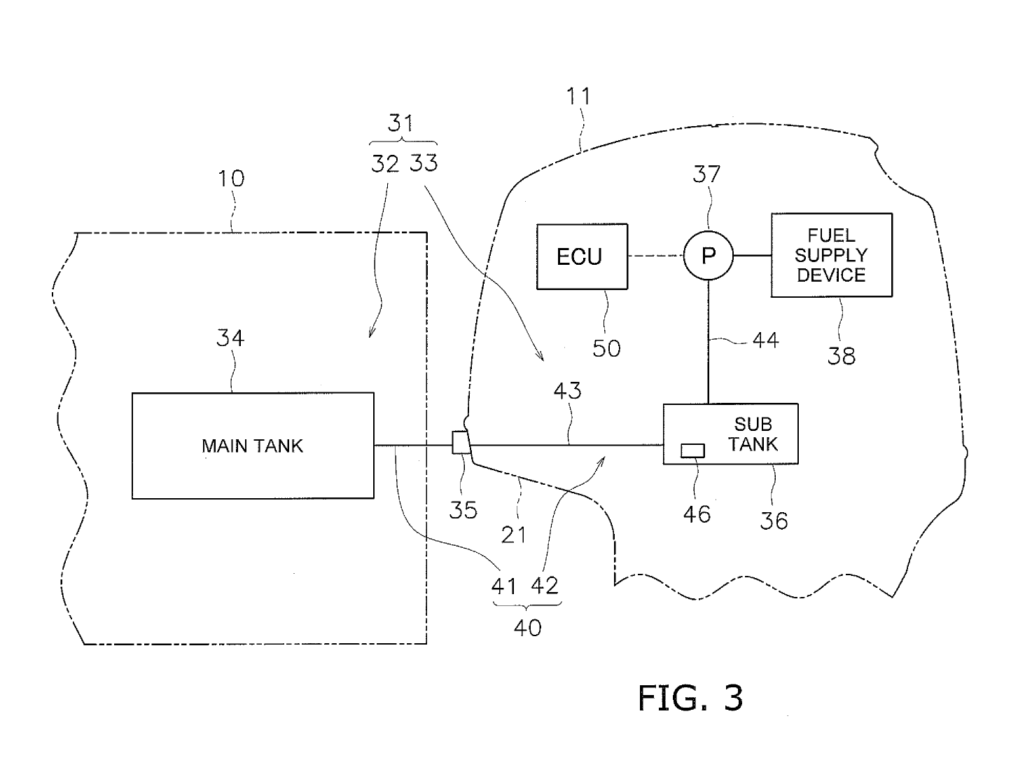

FIG. 3 is a schematic diagram of a fuel supply system 31 of the watercraft 1. As shown in FIG. 3, the fuel supply system 31 includes an outside fuel supply system 32 and an inside fuel supply system 33. The outside fuel supply system 32 includes a main tank 34. The main tank 34 is disposed on the hull 10. The main tank 34 stores fuel.

The inside fuel supply system 33 is disposed in the marine propulsion device 11. The engine 22 of the marine propulsion device 11 is configured to cause rotation of the crankshaft 27 by combusting the fuel supplied from the inside fuel supply system 33. The inside fuel supply system 33 includes a connector 35, a sub tank 36, and a pump 37.

The connector 35 is connected to the outside fuel supply system 32. The connector 35 is attached to the engine cover 21 and is disposed outside the engine cover 21.

The sub tank 36 stores the fuel. As shown in FIG. 2, the sub tank 36 is attached to the engine 22 and is disposed inside the engine cover 21. It should be noted that the sub tank 36 may be attached to the engine 22 through a bracket, for example.

Alternatively, the sub tank 36 may be attached to the engine 22 through a bracket cushion. The sub tank 36 is a gas-liquid separation tank. It should be noted that the sub tank 36 may be a type of tank without a gas-liquid separation function.

The pump 37 is configured to supply the fuel from the sub tank 36 to a fuel supply device 38 of the engine 22. The pump 37 is disposed inside the engine cover 21. The fuel supply device 38 is configured to supply the fuel, supplied thereto from the pump 37, to the interior of the combustion chamber of the engine 22. For example, the fuel supply device 38 preferably is a fuel injector. Alternatively, the fuel supply device 38 may be a carburetor, for example.

The fuel supply system 31 includes a fuel pipe 40. The fuel pipe 40 connects the main tank 34 and the engine 22. When described in detail, the fuel pipe 40 includes a first pipe portion 41 and a second pipe portion 42. The first pipe portion 41 is connected to the main tank 34. The first pipe portion 41 is included in the outside fuel supply system 32. The first pipe portion 41 is connected to the connector 35 on the outside of the engine cover 21.

The second pipe portion 42 is included in the inside fuel supply system 33. The second pipe portion 42 is disposed inside the engine cover 21. One end of the second pipe portion 42 is connected to the engine 22. The other end of the second pipe portion 42 is connected to the connector 35 at an interior of the engine cover 21. In other words, the second pipe portion 42 is connected to the first pipe portion 41 through the connector 35.

When described in further detail, the second pipe portion 42 includes an upstream pipe 43 and a downstream pipe 44. The upstream pipe 43 is located upstream of the sub tank 36 in a fuel supply path. In other words, the upstream pipe 43 connects the sub tank 36 and the connector 35. The downstream pipe 44 is located downstream of the sub tank 36 in the fuel supply path. In other words, the downstream pipe 44 connects the sub tank 36 and the pump 37.

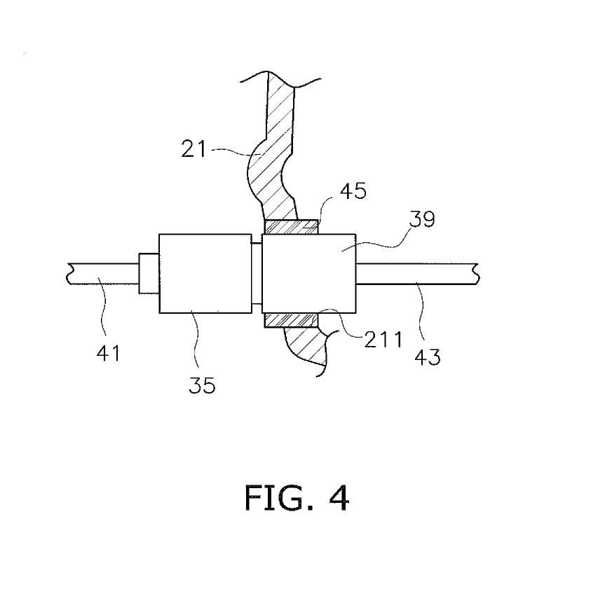

FIG. 4 is an enlarged cross-sectional view of a structure including the connector 35 and the surrounding elements. As shown in FIG. 4, the connector 35 is attached to the outer surface of the engine cover 21. The upstream pipe 43 includes a connector 39. A through hole 211 is provided in the engine cover 21. A seal member 45 is attached to the through hole 211, and the connector 39 of the upstream pipe 43 is supported by the engine cover 21 by the seal member 45.

As shown in FIG. 3, the marine propulsion device 11 includes a phase separation detecting sensor 46. The phase separation detecting sensor 46 is configured to detect a possibility of occurrence of phase separation in the fuel. The phase separation detecting sensor 46 is disposed inside the engine cover 21. The phase separation detecting sensor 46 is attached to the inside fuel supply system 33 disposed downstream of the connector 35. When described in detail, the phase separation detecting sensor 46 is disposed inside the sub tank 36.

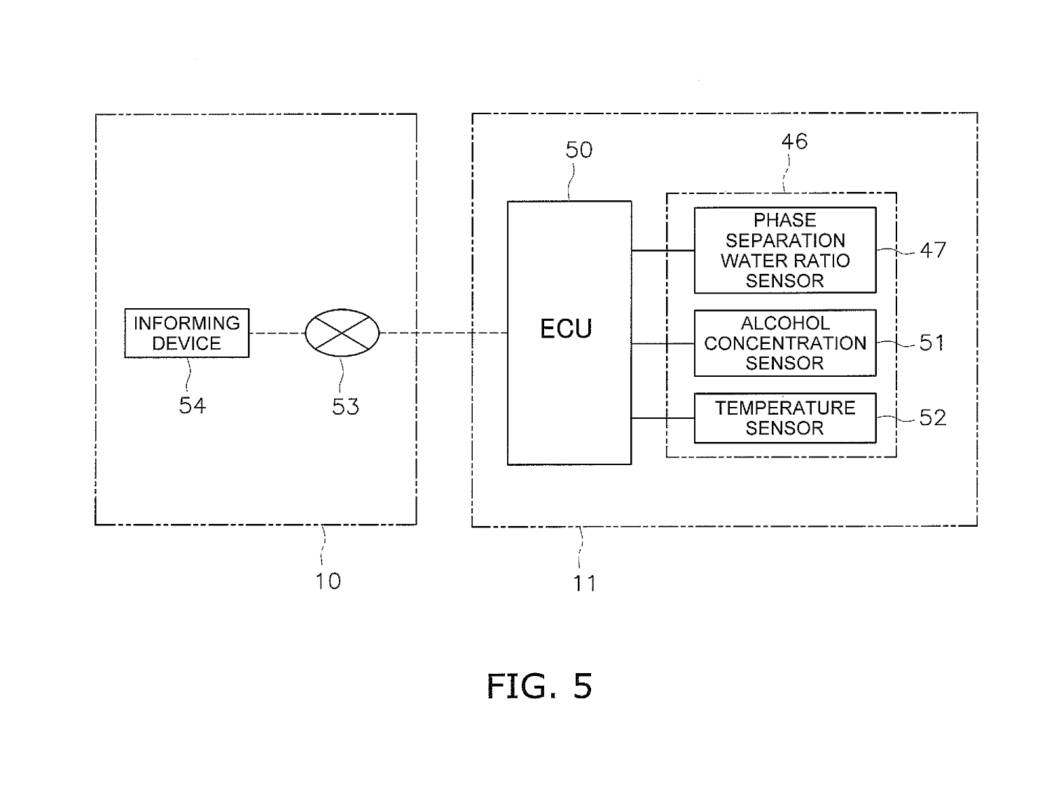

FIG. 5 is a schematic diagram of a communication system of the watercraft 1. As shown in FIG. 5, the phase separation detecting sensor 46 includes a phase separation water ratio sensor 47, an alcohol concentration sensor 51, and a temperature sensor 52. The phase separation water ratio sensor 47 is configured to detect the phase separation water ratio of the fuel stored in the sub tank 36. The phase separation water ratio herein indicates a ratio of an actual amount of water to an amount of water causing phase separation in an alcohol containing fuel (hereinafter referred to as a boundary amount of water). The alcohol concentration sensor 51 is configured to detect the alcohol concentration in the alcohol containing fuel. The temperature sensor 52 is configured to detect the temperature of the alcohol containing fuel.

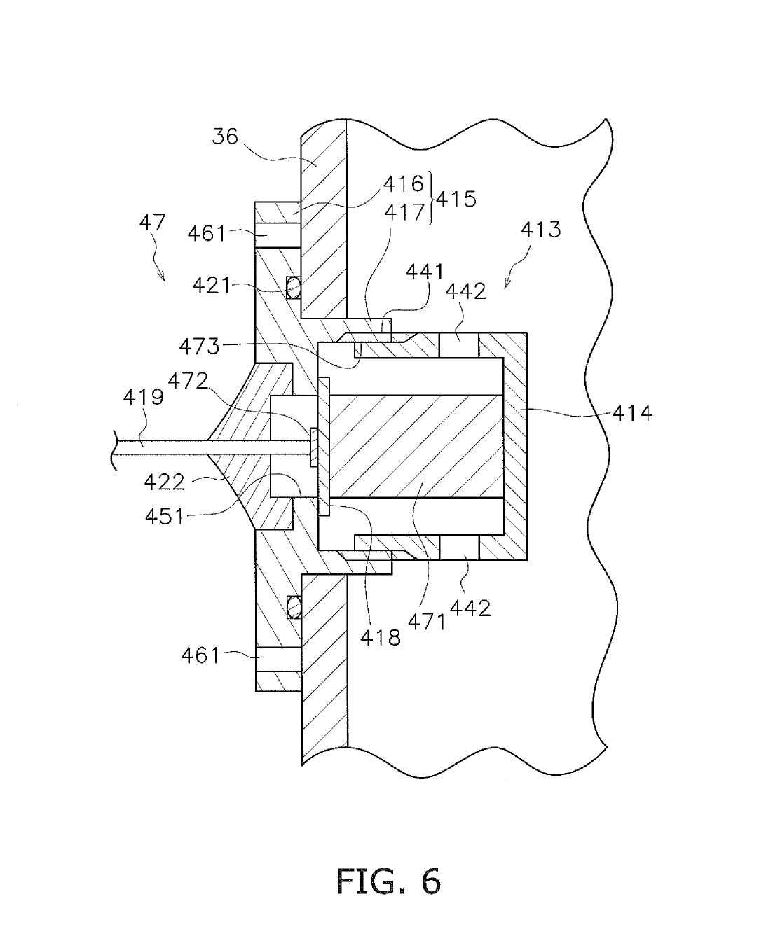

FIG. 6 is a schematic diagram of the phase separation water ratio sensor 47. The phase separation water ratio sensor 47 is attached to the sub tank 36. As shown in FIG. 6, the phase separation water ratio sensor 47 includes a detection portion 471 and an output portion 472. The detection portion 471 is made of a material that changes in accordance with the phase separation water ratio. In the present preferred embodiment, the alcohol containing fuel includes a gasoline fuel that contains ethanol. However, the alcohol containing fuel may be another type of alcohol containing fuel.

The phase separation water ratio sensor 47 includes a case 413. The case 413 includes a housing portion 414 and an attachment portion 415. The housing portion 414 accommodates the detection portion 471. The attachment portion 415 is attached to the sub tank 36. The attachment portion 415 includes a flange portion 416 and a tubular portion 417. The flange portion 416 includes attachment holes 461. The flange portion 416 is attached to the sub tank 36 by inserting screws, for example, (not shown in the drawings) through the attachment holes 461. A clearance between the flange portion 416 and the sub tank 36 is sealed by an O-ring 421.

The tubular portion 417 includes a female threaded portion 473 on the inner peripheral surface thereof. The housing portion 414 includes a male threaded portion 441 on the outer peripheral surface thereof. The housing portion 414 is attached to the attachment portion 415 by screwing the male threaded portion 441 of the housing portion 414 into the female threaded portion 473 of the tubular portion 417. A plate member 418 is disposed inside the tubular portion 417. The detection portion 471 is interposed and held between the plate member 418 and the housing portion 414. Thus, a compression preload is applied to the detection portion 471.

The housing portion 414 includes immersion apertures 442. The fuel stored in the sub tank 36 flows into the housing portion 414 through the immersion apertures 442. The attachment portion 415 includes a lead hole 451. The lead hole 451 is opposed to the plate member 418. The output portion 472 is attached to the plate member 418. A lead wire 419, connected to the output portion 472, is inserted through the lead hole 451. A clearance between the lead hole 451 and the lead wire 419 is sealed by a molding 422.

The detection portion 471 is made of a material having swelling properties. In other words, the detection portion 471 is preferably made of a material that swells by absorption of water contained in the fuel. A swelling ratio of the detection portion 471 varies in accordance with the phase separation water ratio. When described in detail, the swelling ratio of the detection portion 471 increases with an increase in the phase separation water ratio.

The detection portion 471 is preferably made of resin, for example. The detection portion 471 is more preferably made of polyamide-based resin, for example. In the present preferred embodiment, the detection portion 471 is preferably made of PA6 (nylon 6), for example. Alternatively, the detection portion 471 may be made of another material having swelling properties such as NBR (nitrile rubber), for example.

The output portion 472 is configured to output a signal in accordance with the swelling ratio of the detection portion 471. For example, the swelling ratio is a volume change ratio of the detection portion 471. In the present preferred embodiment, the output portion 472 includes a strain gauge. The output portion 472 is configured to convert the volume change ratio of the detection portion 471 into an electric signal and output the electric signal. It should be noted that the swelling ratio may be a weight change ratio of the detection portion 471. Further, the output portion 472 may be any one selected from the group of a pressure sensor, a pressure switch, and a limit switch as long as it is capable of detecting a swelling-related change in the detection portion 471.

As shown in FIG. 5, the marine propulsion device 11 includes an ECU (electric control unit) 50. As shown in FIG. 2, the ECU 50 is disposed inside the engine cover 21 and is attached to the engine 22. It should be noted that the ECU 50 may be attached to the engine 22 by a bracket.

The ECU 50 includes an arithmetic-and-logic unit such as a CPU. Further, the ECU 50 includes a semiconductor memory (e.g., a RAM, a ROM, etc.) or a storage device (e.g., a hard disc drive, a flash memory, etc.). The ECU 50 stores programs and data that control the marine propulsion device 11.

The ECU 50 is connected to the steering device 14 and the remote control device 15 so as to be in communication therewith. The ECU 50 is configured to control the engine 22 based on signals from the steering device 14, the remote control device 15 and so forth. Further, the ECU 50 is configured to control the pump 37 and is connected to the pump 37 so as to be in communication therewith.

The ECU 50 is connected to the alcohol concentration sensor 51, the temperature sensor 52, and the phase separation water ratio sensor 47 so as to be in communication therewith. For example, the ECU 50 is connected to these sensors through wires. The alcohol concentration sensor 51 is configured to output a detection signal indicating the detected alcohol concentration in the alcohol containing fuel to the ECU 50. The temperature sensor 52 is configured to output a detection signal indicating the detected temperature of the alcohol containing fuel to the ECU 50. The phase separation water ratio sensor 47 is configured to output an electric signal in accordance with the phase separation water ratio of the fuel in the sub tank 36.

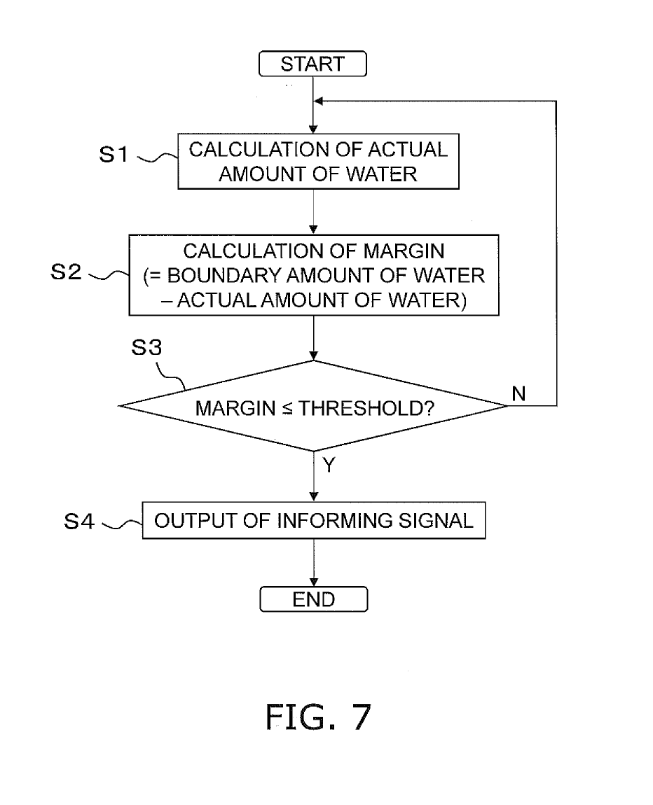

The ECU 50 is configure or programmed to output an informing signal when a determination is made that the possibility of an occurrence of phase separation is high based on the outputs of the above described sensors. In other words, the ECU 50 is configured or programmed to evaluate the possibility of an occurrence of phase separation based on the phase separation water ratio. FIG. 7 is a flowchart representing a process performed by the ECU 50.

As represented in FIG. 7, in Step S1, the ECU 50 calculates the actual amount of water in the alcohol containing fuel. When described in detail, the ECU 50 calculates the phase separation water ratio based on the signal from the phase separation water ratio sensor 47, and calculates the actual amount of water based on the phase separation water ratio and the boundary amount of water.

The boundary amount of water is set in accordance with the ethanol concentration in the fuel and the temperature of the fuel. The ethanol concentration in the fuel is determined based on the signal from the alcohol concentration sensor 51. The temperature of the fuel is determined based on the signal from the temperature sensor 52. For example, the ECU 50 stores information such as a table or map that defines a relation among the alcohol concentration, the temperature of the alcohol containing fuel, and the boundary amount of water. The ECU 50 calculates the boundary amount of water by referring to this information.

In Step S2, the ECU 50 calculates a margin. The margin is calculated by subtracting the actual amount of water from the boundary amount of water.

In Step S3, the ECU 50 determines whether or not the margin is less than or equal to a threshold. The process returns to Step S1 when the ECU 50 determines that the margin is not less than or equal to the threshold. Contrarily, the process proceeds to Step S4 when the ECU 50 determines that the margin is less than or equal to the threshold.

In Step S4, the ECU 50 outputs the informing signal. Specifically, when a determination is made that the margin is less than or equal to the threshold, the ECU 50 determines that the possibility of occurrence of phase separation is high, and outputs the informing signal.

It should be noted that the ECU 50 may evaluate the possibility of occurrence of phase separation by turning on/off a main switch or at another timing.

As shown in FIG. 5, the hull 10 includes a communication device 53 defining an on-board LAN. The ECU 50 is connected to the on-board LAN preferably through wires, for example. It should be noted that the ECU 50 may be connected to the on-board LAN through a wireless communication.

An informing device 54 is disposed on the hull 10. The informing device 54 is connected to the ECU 50 through the on-board LAN so as to be in communication therewith. The informing signal from the ECU 50 is transmitted to the informing device 54 through the on-board LAN. When receiving the informing signal from the ECU 50, the informing device 54 informs that the possibility of occurrence of phase separation is high.

When described in detail, the informing device 54 is configured to issue a warning when the ECU 50 outputs the informing signal to the informing device 54. The informing device 54 is installed in the indication device 16. For example, the informing device 54 preferably is a warning light, and is configured to issue a warning by lighting the warning light, for example. It should be noted that the informing device 54 is not limited to the warning light and may be another informing device. For example, the informing device 54 may be a warning indication including characters and/or diagrams displayed on a screen. Alternatively, the informing device 54 may be a device configured to output audio information by a buzzer or speaker.

In the watercraft 1 according to the present preferred embodiment explained above, the phase separation detecting sensor 46 is configured to detect the possibility of occurrence of phase separation in the fuel in the fuel supply system 31. The ECU 50 is configured or programmed to output the informing signal when a determination is made that the possibility of occurrence of phase separation is high based on the output of the phase separation detecting sensor 46. When the ECU 50 outputs the informing signal, the informing device 54 is configured to inform that the possibility of occurrence of phase separation is high. The indication by the informing device 54 enables a user of the watercraft 1 to recognize that the possibility of occurrence of phase separation in the alcohol containing fuel is high. Occurrence of phase separation in the alcohol containing fuel is thus preliminarily prevented.

Further, the phase separation detecting sensor 46 is disposed inside the sub tank 36, and is therefore included in the inside fuel supply system 33. The inside fuel supply system 33 is disposed inside the marine propulsion device 11 together with the ECU 50. If the phase separation detecting sensor 46 was disposed in the outside fuel supply system 32, the phase separation detecting sensor 46 and the ECU 50 would be required to be reconnected so as to be in communication with each other whenever the marine propulsion device 11 is detached from the hull 10. However, in the watercraft 1 according to the present preferred embodiment, the phase separation detecting sensor 46 is disposed in the inside fuel supply system 33. Thus, reconnection is not required whenever the connector 35 is detached. Accordingly, the marine propulsion device 11 is easily attached to or detached from the hull 10.

Preferred embodiments of the present invention have been explained above. However, the present invention is not limited to the above described preferred embodiments, and a variety of changes can be made without departing from the scope of the present invention.

In the above described preferred embodiments, the phase separation detecting sensor 46 is preferably disposed inside the sub tank 36. However, the sub tank 36 may not be provided. Alternatively, the position of the phase separation detecting sensor 46 is not limited to the interior of the sub tank 36 as described in the above preferred embodiments, and may be changed to another position.

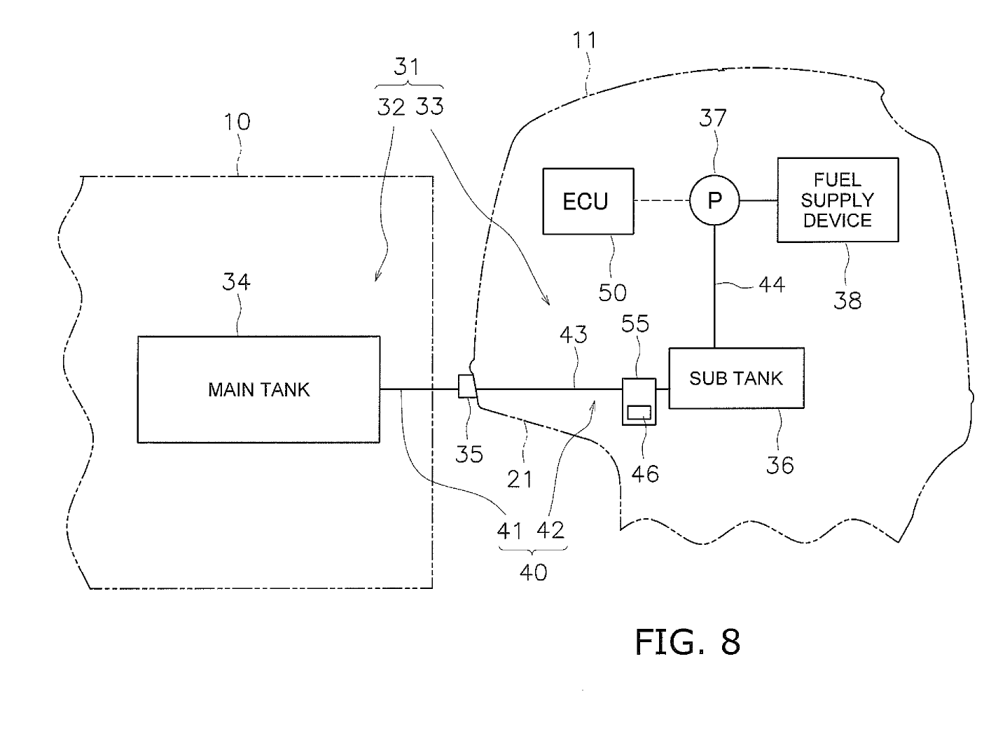

For example, as with a first modification shown in FIG. 8, the fuel supply system 31 may include a water separation filter 55, and the phase separation detecting sensor 46 may be mounted to or embedded in the water separation filter 55. The water separation filter 55 is configured to separate water contained in the fuel. The water separation filter 55 is disposed inside the marine propulsion device 11. When described in detail, the water separation filter 55 is disposed between the connector 35 and the sub tank 36 in the fuel supply path. It should be noted that the water separation filter 55 may be disposed on the hull 10. When described in detail, the water separation filter 55 may be disposed between the main tank 34 and the connector 35 in the fuel supply path.

In the above described preferred embodiments, the phase separation detecting sensor 46 is preferably attached to the engine 22 through the sub tank 36. However, the phase separation detecting sensor 46 may be attached to the engine cover 21. In this configuration, the phase separation detecting sensor 46 is preferably attached to the engine cover 21 through a cushioning member. For example, when the phase separation detecting sensor 46 is disposed inside the sub tank 36, the sub tank 36 is attached to the engine cover 21. Alternatively, when the phase separation detecting sensor 46 is disposed inside the water separation filter 55, the water separation filter 55 is preferably attached to the engine cover 21.

The structure of the phase separation detecting sensor 46 is not limited to that described in the above described preferred embodiments, and may be changed. For example, the structure of the case 413 may be changed.

Alternatively, the phase separation detecting sensor 46 may be attached to the second pipe portion 42. In this configuration, for example, the phase separation detecting sensor 46 is preferably attached to the upstream pipe 43. Instead, the phase separation detecting sensor 46 may be attached to the downstream pipe 44. Even in this configuration, similarly to the above described preferred embodiments, the phase separation detecting sensor 46 is disposed downstream of the connector 35 in the fuel supply path. Thus, the ECU 50 and the phase separation detecting sensor 46 are not required to be reconnected to each other whenever the marine propulsion device 11 is detached from the hull 10, i.e., whenever the first pipe portion 41 is detached from the connector 35. Accordingly, the marine propulsion device 11 is easily attached to or detached from the hull 10.

Yet alternatively, the phase separation detecting sensor 46 may be attached to the outside fuel supply system 32. For example, the phase separation detecting sensor 46 may be disposed in the first pipe portion 41. Yet further alternatively, the phase separation detecting sensor 46 may be disposed in the main tank 34.

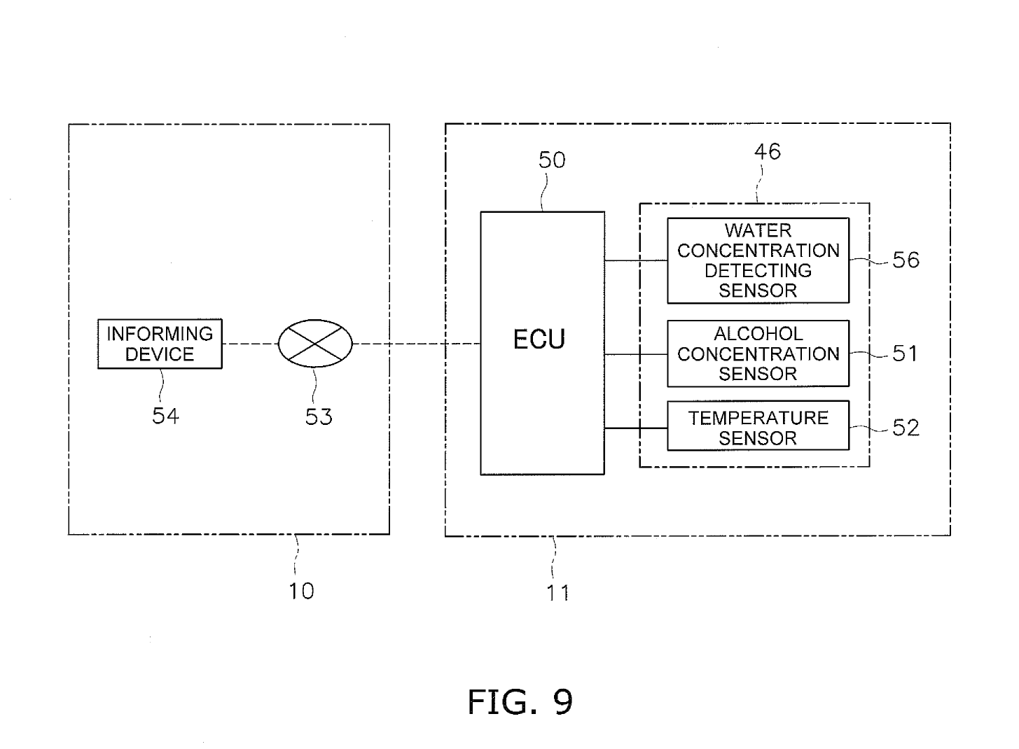

In the above described preferred embodiments, the phase separation detecting sensor 46 preferably includes the phase separation water ratio sensor 47. However, as with a second modification shown in FIG. 9, the phase separation detecting sensor 46 may include a water concentration detecting sensor 56. The water concentration detecting sensor 56 is configured to detect the water concentration in the fuel. Further, in Step S1 of the flowchart shown in FIG. 7, the actual amount of water is determined based on a signal from the water concentration detecting sensor 56.

The phase separation detecting sensor 46 may not be provided with the alcohol concentration sensor 51 and/or the temperature sensor 52. In this configuration, the possibility of occurrence of phase separation is evaluated based on comparison of an output value from the phase separation water ratio sensor with a predetermined threshold.

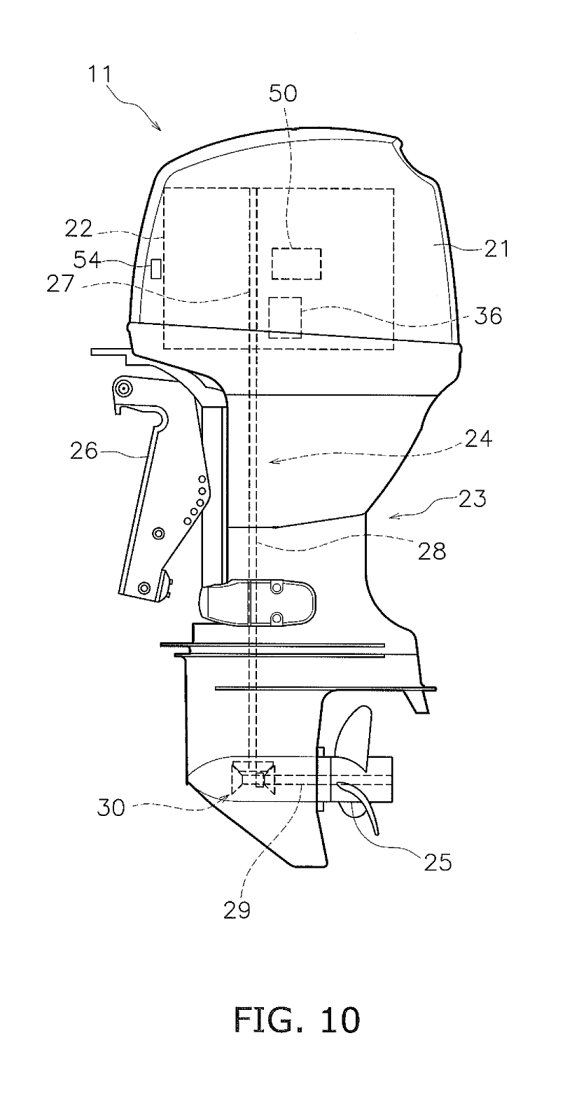

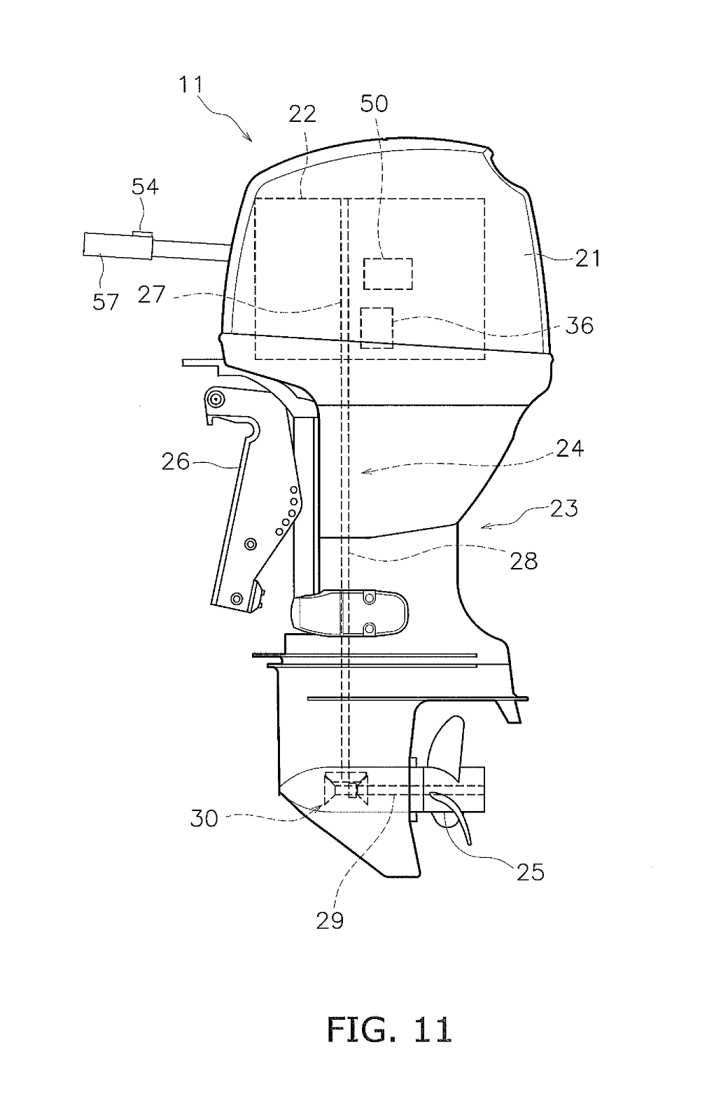

In the above described preferred embodiments, the informing device 54 is preferably disposed on the hull 10. However, the positional arrangement of the informing device 54 is not limited to that described in the above preferred embodiments, and may be changed. For example, as with a third modification shown in FIG. 10, the informing device 54 may be disposed in the marine propulsion device 11. As shown in FIG. 10, in the marine propulsion device 11 according to the third modification, the informing device 54 is mounted to the engine cover 21. Alternatively, as with a fourth modification shown in FIG. 11, the informing device 54 is attached to a tiller handle 57.

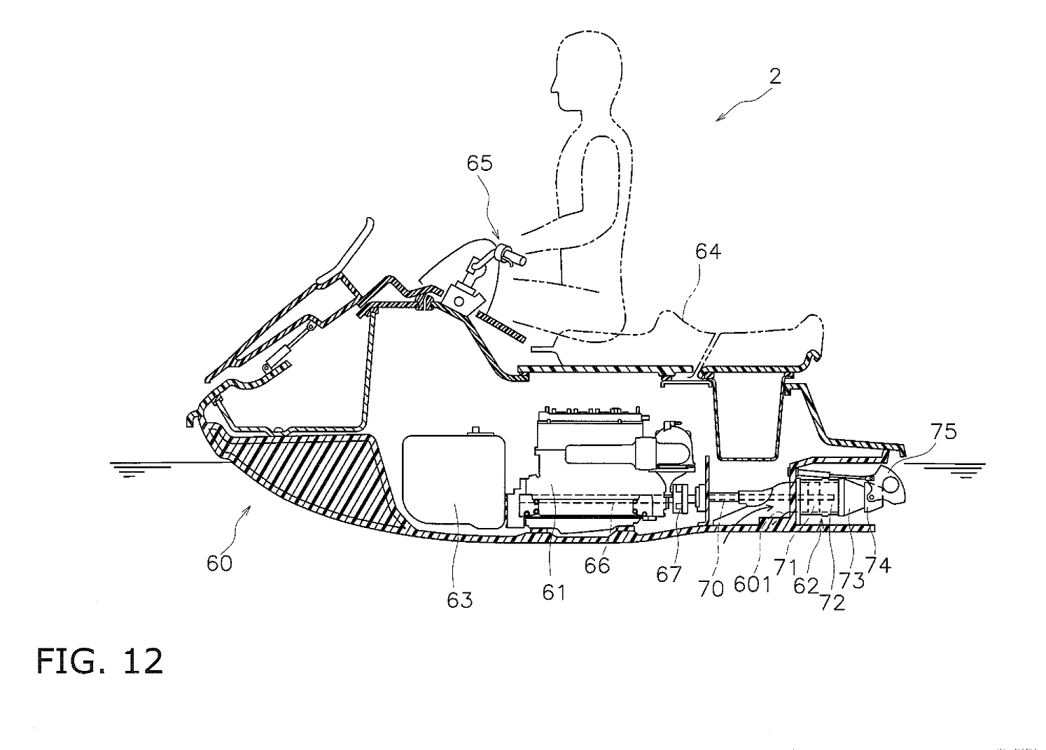

The marine propulsion device 11 is not limited to an outboard motor and may be another device such as an inboard-outboard motor. Further, the watercraft 1 may be another type of watercraft such as a jet propelled watercraft. For example, the jet propelled watercraft may be a jet boat. Alternatively, the jet propelled watercraft may be a personal watercraft (PWC) such as a jet propelled watercraft 2 according to another preferred embodiment shown in FIG. 12.

As shown in FIG. 12, the jet propelled watercraft 2 includes a hull 60, an engine 61, and a jet propulsion device 62. The engine 61 is accommodated in the hull 60. The jet propulsion device 62 is configured to be driven by the engine 61. A fuel tank 63 is accommodated in the hull 60. The phase separation detecting sensor 46 is preferably disposed inside the fuel tank 63. A seat 64 is attached to the hull 60. The seat 64 is disposed over the engine 61. A steering 65 to steer the hull 60 is disposed forward of the seat 64.

The engine 61 includes a crankshaft 66. The crankshaft 66 is disposed so as to extend in the back-and-forth direction. A coupling 67 is disposed rearward of the crankshaft 66. The coupling 67 couples the crankshaft 66 and an impeller shaft 70 to be described below.

The jet propulsion device 62 is configured to suck and eject water that surrounds the hull 60. The jet propulsion device 62 includes the impeller shaft 70, an impeller 71, an impeller housing 72, a nozzle 73, a deflector 74, and a bucket 75. The impeller shaft 70 is disposed so as to extend in the back-and-forth direction. The rear portion of the impeller shaft 70 is introduced into the impeller housing 72 through a water suction portion 601 of the hull 60. The impeller housing 72 is connected to the rear portion of the water suction portion 601. The nozzle 73 is disposed rearward of the impeller housing 72.

The impeller 71 is attached to the rear portion of the impeller shaft 70. The impeller 71 is disposed inside the impeller housing 72. The impeller 71 is configured to be rotated together with the impeller shaft 70 in order to cause the water suction portion 601 to suck water. The impeller 71 is configured to backwardly eject the sucked water through the nozzle 73. The deflector 74 is disposed rearward of the nozzle 73. The deflector 74 is configured to switch the direction of water ejected through the nozzle 73 in the right-and-left direction. The bucket 75 is disposed rearward of the deflector 74. The bucket 75 is configured to switch the direction of water ejected through the nozzle 73 and the deflector 74 toward the front of the jet propelled watercraft 2.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A watercraft comprising:
a hull;
an engine attached to the hull;
a fuel supply system including a fuel tank disposed on the hull and a fuel pipe connecting the fuel tank and the engine;
a phase separation detecting sensor attached to the fuel supply system and configured to detect a possibility of occurrence of phase separation in a fuel;
a control unit configured or programmed to output an informing signal when a determination is made that the possibility of occurrence of phase separation in the fuel is high based on an output of the phase separation detecting sensor; and
an informing device configured to indicate that the possibility of occurrence of phase separation in the fuel is high when the informing signal is received from the control unit.

2. The watercraft according to claim 1, wherein the phase separation detecting sensor includes a detection portion made of a material that swells due to absorption of water contained in the fuel; and
the phase separation detecting sensor is configured to detect a swelling amount of the detection portion.

3. The watercraft according to claim 1, wherein the phase separation detecting sensor includes:
an alcohol concentration sensor configured to detect an alcohol concentration in the fuel; and
a water concentration detecting sensor configured to detect a water concentration in the fuel.

4. The watercraft according to claim 1, wherein the fuel pipe includes:
a first pipe portion connected to the fuel tank;
a second pipe portion connected to the engine; and
a connector connecting the first pipe portion and the second pipe portion; wherein
the phase separation detecting sensor is attached to the second pipe portion.

5. The watercraft according to claim 1, wherein the fuel supply system further includes a water separation filter configured to separate water contained in the fuel, and the phase separation detecting sensor is disposed in the water separation filter.

6. The watercraft according to claim 1, wherein the fuel supply system further includes a sub tank configured to store the fuel, and the phase separation detecting sensor is disposed in the sub tank.

7. The watercraft according to claim 1, wherein the hull includes a vessel operating seat disposed forward of the engine, and the informing device is disposed in a vicinity of the vessel operating seat.

8. The watercraft according to claim 1, wherein the hull includes a communication device defining an on-board LAN, and the informing device is connected to the control unit through the on-board LAN so as to be in communication therewith.

9. The watercraft according to claim 1, wherein the control unit is configured or programmed to evaluate the possibility of occurrence of phase separation in the fuel based on a ratio of an actual amount of water to a boundary amount of water causing phase separation in the fuel.

10. The watercraft according to claim 9, wherein the boundary amount of water is set in accordance with an ethanol concentration in the fuel and a temperature of the fuel.

11. A marine propulsion device configured to be attached to a hull, the marine propulsion device comprising:
an inside fuel supply system including:
a connector configured to be connected to an outside fuel supply system including a fuel tank disposed on the hull;
a sub tank configured to store a fuel; and
a pump configured to supply the fuel from the sub tank to an engine;
the engine including a crankshaft and configured to cause the crankshaft to be rotated by combusting the fuel supplied from the inside fuel supply system;
a drive shaft connected to the crankshaft; and
a phase separation detecting sensor attached to the inside fuel supply system and configured to detect a possibility of occurrence of phase separation in the fuel.

12. The marine propulsion device according to claim 11, wherein the sub tank is attached to the engine.

13. The marine propulsion device according to claim 11, wherein the sub tank is a gas-liquid separation tank.

14. The marine propulsion device according to claim 11, further comprising a control unit connected to the phase separation detecting sensor so as to be in communication therewith.

15. The marine propulsion device according to claim 14, wherein the control unit is attached to the engine.

16. The marine propulsion device according to claim 11, further comprising:
an engine cover configured to accommodate the engine therein; wherein
the sub tank, the pump, and the phase separation detecting sensor are disposed inside the engine cover.

17. The marine propulsion device according to claim 16, wherein the phase separation detecting sensor is attached to either the engine or the engine cover through a cushioning material.

18. The marine propulsion device according to claim 16, wherein the connector is disposed outside the engine cover, and the inside fuel supply system further includes a fuel pipe connecting the connector and the sub tank.

19. The marine propulsion device according to claim 18, wherein the fuel pipe is supported by the engine cover through a seal member.

20. The marine propulsion device according to claim 11, further comprising:
a control unit connected to the phase separation detecting sensor so as to be in communication therewith; wherein
the control unit is configured or programmed to evaluate a possibility of phase separation in the fuel in accordance with an output value of the phase separation detecting sensor.

21. The marine propulsion device according to claim 20, wherein the control unit is configured or programmed to output an informing signal when a determination is made that the possibility of occurrence of phase separation in the fuel is high.

22. The marine propulsion device according to claim 21, wherein the control unit is configured to output the informing signal to an on-board LAN on the hull, and the control unit is configured to be connected to the on-board LAN so as to be in communication therewith.

23. The marine propulsion device according to claim 22, wherein the control unit is configured to transmit the informing signal to an informing device, and the informing device is disposed on the hull and connected to the control unit through the on-board LAN so as to be in communication therewith.

24. The marine propulsion device according to claim 21, further comprising:
an informing device connected to the control unit so as to be in communication therewith; wherein
the control unit is configured or programmed to output an informing signal to the informing device when a determination is made that the possibility of occurrence of phase separation in the fuel is high.
